(19) United States
(12) Patent Application Publication
(10) Pub. No.: US 2023/0323838 A1
(43) Pub. Date: Oct. 12, 2023

(54) ADVANCED MONOPROPELLANT THRUSTER

(71) Applicant: Skyrocket Industries, LLC, Longmont, CO (US)

(72) Inventor: Jesse Dutton, Longmont, CO (US)

(21) Appl. No.: 18/164,369

(22) Filed: Feb. 3, 2023

Related U.S. Application Data
(60) Provisional application No. 63/269,494, filed on Mar. 17, 2022.

(51) Int. Cl. F02K 9/42; F02K 9/68

(52) U.S. Cl. CPC F02K 9/425; F02K 9/68

(57) ABSTRACT

A monopropellant rocket thruster includes a thruster, a pump, a decomposition catalyst, and an igniter. The thruster housing includes a reaction chamber and a divergent nozzle. The pump, coupled to the thruster housing, is operable to pump a monopropellant liquid into an inlet of the reaction chamber. The decomposition catalyst, located near the inlet between the pump and the reaction chamber, is configured to decompose at least one component of the monopropellant liquid into a mixture of liquid and gas in an exothermic reaction. The igniter is disposed at an outlet of the reaction chamber, such that the igniter ignites the mixture of liquid and gas for producing expanding gas into the divergent nozzle.

### RELATED APPLICATIONS

This application claims priority to U.S. Provisional Application No. 63/269,494, filed on Mar. 17, 2022. The application is incorporated herein by reference in its entirety.

### BACKGROUND

A typical rocket thruster employs a de Laval nozzle, which is a convergent-divergent nozzle. At the smallest point of convergence, where the velocity of the exhaust gas is greatest, the flow of exhaust gas is limited and becomes choked. Attempts to increase a mass flow rate may result in exceeding the limits of the pressure chamber.

### SUMMARY

Embodiments disclosed herein use monopropellants and not requiring a pressure chamber to produce thrust in a rocket engine. In a first aspect, a monopropellant rocket thruster includes a thruster, a pump, a decomposition catalyst, and an igniter. The thruster housing includes a reaction chamber and a divergent nozzle. The pump, coupled to the thruster housing, is operable to pump a monopropellant liquid into an inlet of the reaction chamber. The decomposition catalyst, located near the inlet between the pump and the reaction chamber, is configured to decompose at least one component of the monopropellant liquid into a mixture of liquid and gas in an exothermic reaction. The igniter is disposed at an outlet of the reaction chamber, such that the igniter ignites the mixture of liquid and gas for producing expanding gas into the divergent nozzle.

In a second aspect, a method for producing thrust in a rocket thruster includes (i) pumping a monopropellant liquid into an inlet of a reaction chamber of the rocket thruster; (ii) decomposing at least one component of the monopropellant liquid into a mixture of liquid and gas in an exothermic reaction using a catalyst near an inlet of the reaction chamber; and (iii) igniting the mixture of liquid and gas near an outlet of the reaction chamber for producing expanding gas into a divergent nozzle of the rocket thruster.

### BRIEF DESCRIPTION OF THE FIGURES

FIG. 1 illustrates a cross-sectional view of a rocket thruster nozzle, in an embodiment.

FIG. 2 illustrates a monopropellant thruster, in an embodiment.

FIG. 3 illustrates an ignition system, in an embodiment.

FIG. 4 is a flowchart illustrating a method for producing thrust, in an embodiment.

### DETAILED DESCRIPTION

Reference throughout this specification to “one example” or “one embodiment” means that a particular feature, structure, or characteristic described in connection with the example is included in at least one example of the present invention. Thus, the appearances of the phrases “in one example” or “in one embodiment” in various places throughout this specification are not necessarily all referring to the same example. Furthermore, the particular features, structures, or characteristics may be combined in any suitable manner in one or more examples.

FIG. 1 illustrates an example thruster 100. Thruster 100 may be a conventional de Laval nozzle. A de Laval nozzle is a convergent-divergent nozzle, which at the opposite ends converges and then diverges. In a conventional rocket engine, injectors spray a propellant into a pressure chamber, where the liquids vaporize and are ignited. Accordingly, thruster 100 includes a pressure chamber 105, a convergent nozzle 102 and a divergent nozzle 126. As a propellant builds pressure in pressure chamber 105 and enters convergent nozzle 102 in a propellant direction 110, a cross-sectional area 123 of the propellant at an inlet 124 decreases to a convergent cross-sectional area 103 in convergent nozzle 102 then increases to a divergent cross-sectional area 125 in divergent nozzle 126. Accordingly, inside pressure chamber 105, pressure and temperature build, and at the smallest point of convergence, at a nozzle throat 130, the velocity of the propellant reaches the highest velocity. However, because the highest velocity is restricted by pressure, it may not exceed the speed of sound in the exhaust. The restricted flow of this exhaust is referred to as the choked flow because the amount of mass per second that can be ejected from the rocket is restricted. Exceeding this mass flow rate may lead to a rupture of the pressure chamber. The force generated by the rocket is the product of its mass per second and the velocity of the exhaust:

$$F = \dot{m} {v}_{e} ,$$

where ṁ is mass flow rate, and νₑ is exit velocity at nozzle exit. Current rocket technology attempts to maximize the exhaust temperature, which increases the speed of sound in the exhaust gas, which may then increase the maximum velocity of the rocket.

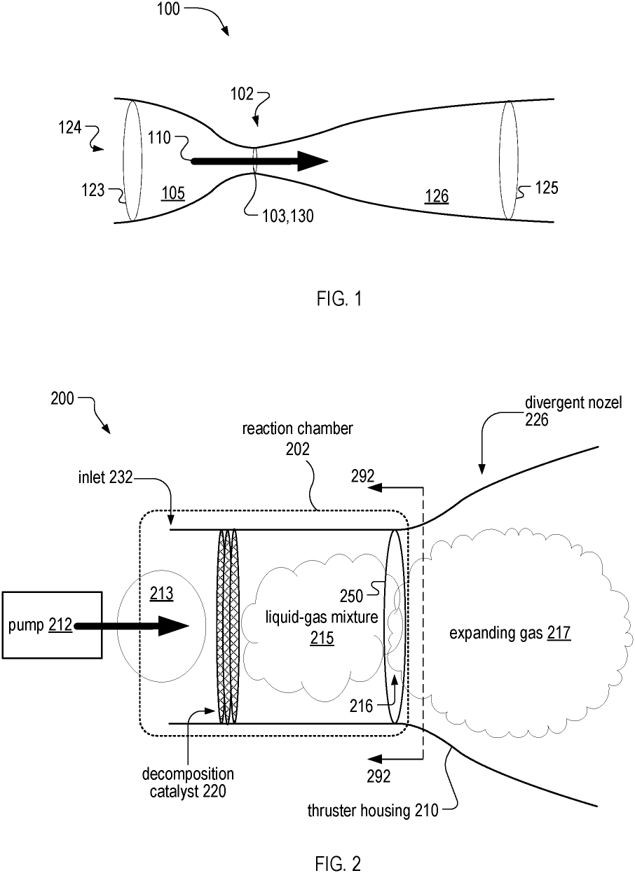

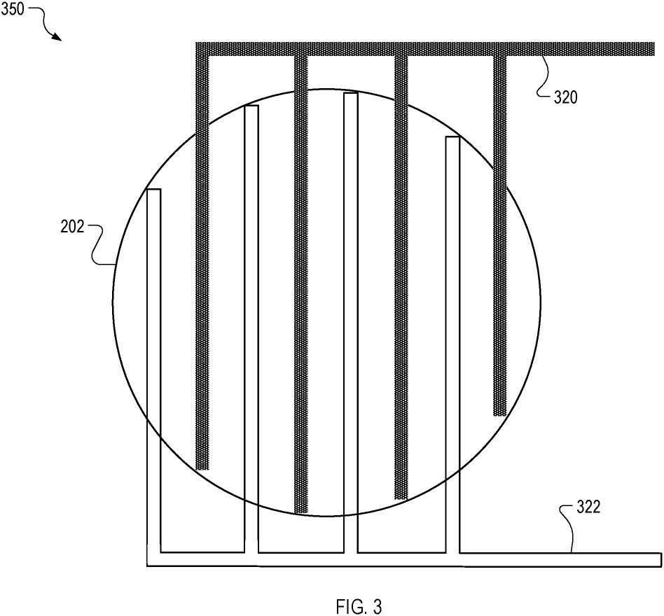

Embodiments disclosed hereinbelow describe a monopropellant thruster, which improves upon thruster 100 and remedies the limit imposed by the choked flow by, in part, removing the need for a convergent nozzle. FIG. 2 illustrates an example of a monopropellant rocket thruster 200. A monopropellant rocket thruster 200 includes a thruster housing 210, a pump 212, a decomposition catalyst 220, and an ignition system 250. Thruster housing 210 includes a reaction chamber 202 and a divergent nozzle 226. In an example of operation, pump 212 pumps a monopropellant liquid 213 into an inlet of reaction chamber 202. Decomposition catalyst 220 decomposes at least one component of monopropellant liquid 213 into a liquid-gas mixture 215 in an exothermic reaction near the inlet of reaction chamber 202. Ignition system 250, or an igniter, disposed at an outlet of reaction chamber 202, ignites liquid-gas mixture 215 liquid and gas for producing expanding gas 217 into divergent nozzle 226. In embodiments, decomposition catalyst 220 includes at least one metal screen, which may be electroplated with platinum. Decomposition catalyst 220 may also be electroplated with any platinum group metal (e.g., Pt, Os, Ir, Pd, Ru, Rh), gold, or magnesium dioxide. Ignition system 250, an example of which is detailed in FIG. 3, may include at least one pair of electrodes for creating an electric arc to ignite liquid-gas mixture 215.

Without a convergent nozzle, the monopropellant is not intended to be in gas form as it traverses reaction chamber 202 before being ignited by ignition system 250. Consequently, the choked flow limit on the amount of mass per second that can leave the thruster no longer applies but instead relates to the temperature and vapor pressure in the liquid mixture. As monopropellant liquid-gas mixture 215 exits reaction chamber 202 into divergent nozzle 226, it undergoes a phase transition and becomes a gas. The back pressure of the exhaust gas at this transition point does not choke the flow of the liquid, and any pressure can be overcome with pump 212. Advantageously, the phase change from liquid to gas causes the volume to expand and results in increase in pressure and velocity, resulting in the thruster to produce force as the combination of this velocity and an unchoked mass per second.

In an example of operation, pump 212 pumps monopropellant liquid 213 into reaction chamber 202. In embodiments, and in the following description, monopropellant liquid 213 is a mixture of liquid that includes hydrogen peroxide, water, and ethanol that are well-mixed. Ethanol may also be any miscible fuel, such as methanol and propanol. As monopropellant liquid 213 passes in liquid form from inlet 232 through decomposition catalyst 220, hydrogen peroxide decomposes into water and oxygen in an exothermic reaction. The temperature increase from the reaction raises the temperature of the monopropellant mixtures to at least 80° C., which in turn phase-changes ethanol in the mixture into gas. The resulting liquid-gas mixture 215 passes through ignition system 250, which ignites oxygen and ethanol that are diffused throughout liquid-gas mixture 215, and results in an ignited mixture 216. The additional increase in temperature from the ignition phase-changes water into steam, which in the form of expanding gas 217 provides thrust.

In embodiments, the composition of liquid-gas mixture 215 is optimized to reach a sufficient concentration of phase-changed ethanol gas for thrust after the decomposition of hydrogen peroxide. For example, to reach the boiling point of ethanol, hydrogen peroxide concentration needs to be above 27% weight per weight (w/w). Additionally, to generate sufficient energy to phase-change water, ethanol may be added to reach 10% w/w to a mixture of 45% w/w of hydrogen peroxide. Other optimization points or alternate choices of fuel components may require different ratios of components.

FIG. 2 denotes a section line 292, which indicates the location of the orthogonal cross-sectional side view of an ignition system 350 illustrated in FIG. 3. Ignition system 350 is an example of ignition system 250. Ignition system 350 includes at least one pair of electrodes enclosed in reaction chamber 202. A first electrode 320 and a second electrode 322 of the pair of electrodes may be powered using direct current (DC) or alternating current (AC), such that electrodes 320 and 322 produce an electric arc when powered for igniting liquid-gas mixture 215 as it passes ignition system 350. Among the components of liquid-gas mixture 215 being ignited, the most difficult to arc through is water, but this can be overcome with a high voltage and a small gap between electrodes 320 and 322. In embodiments, the electrical arc produced by the ignition system exceeds the breakdown voltage of liquid. For example, the potential difference between electrodes 320 and 322 may be at least 50 kV. Electrodes 320 and 322 may be arranged in layers such that as liquid-gas mixture 215 flows through electrodes 320 and 322, first electrode 320 is separated from second electrode 322 along the direction of flow by a distance that is small enough to allow an electric arc to form. In embodiments, the distance between the electrodes 320 and 322 is less than 1 millimeter. Electrodes 320 and 322 may also be a series of wires across the outlet of reaction chamber 202 with alternating polarities and a high voltage potential. In another example, electrodes 320 and 322 may be arranged as a pair of interdigitated electrodes, as shown in FIG. 3, for producing an electric arc that efficiently and effectively covers the entire cross-sectional area of reaction chamber 202.

At the point of ignition, liquid-gas mixture 215 may be mostly liquid water with bubbles of oxygen and ethanol. Because the ethanol and reaction oxygen start in solution, they become gases while still diffused in the propellant. The gases have a much higher dielectric constant than the liquid water, which means that the path of least resistance will be through the bubbles, such that the spark may jump around as a result. Accordingly, the electrodes may experience electrical stress from this process.

In an example use of the thruster disclosed herein, monopropellant rocket thruster 200 may be scaled up by pumping propellant through the system. For example, with optimized pump size and monopropellant mixture, the thruster may generate up to 15,550 Newtons of thrust with a specific impulse of 1,342 seconds. Current rockets have a specific impulse of approximately 360 seconds.

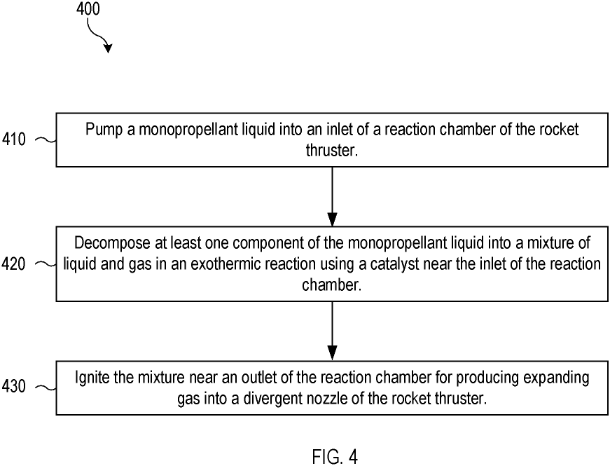

FIG. 4 illustrates a method 400 of producing thrust using a monopropellant thruster. Method 400 includes steps 410, 420, and 430. Method 400 may be implemented using monopropellant rocket thruster 200. Step 410 includes pumping a monopropellant liquid into an inlet of a reaction chamber of the rocket thruster. In an example of step 410, pump 212 in FIG. 2 pumps monopropellant liquid 213 into inlet 232 of reaction chamber 202.

Step 420 includes decomposing at least one component of the monopropellant liquid into a mixture of liquid and gas in an exothermic reaction using a catalyst near the inlet of the reaction chamber. In an example of step 420, as pumped monopropellant liquid 213 of step 410 passes decomposition catalyst 220, hydrogen peroxide in monopropellant liquid 213 decomposes into water and oxygen gas producing heat in an exothermic reaction. The heat produced from the reaction phase-changes ethanol in monopropellant liquid 213 into gas resulting in liquid-gas mixture 215 that may include water, oxygen gas, and ethanol gas. Liquid-gas mixture 215 then continues to flow from decomposition catalyst 220 toward ignition system 250 in reaction chamber 202.

Step 430 includes igniting the mixture of liquid and gas near an outlet of the reaction chamber for producing an expanding gas into a divergent nozzle of the rocket thruster. In an example of step 430, ignition system 350 in FIG. 3 generates electric arc between electrodes 320 and 322 as liquid-gas mixture 215 flows through ignition system 350. The electric arc ignites oxygen and ethanol gas that are diffused throughout liquid-gas mixture 215, which produces additional heat. The additional heat phase-changes water in liquid-gas mixture 215 into steam, which becomes part of expanding gas 217. Advantageously, as the water in liquid-gas mixture 215 becomes steam, it expands greatly, multiplying the velocity of the exhaust stream. This design allows more energy to be available for phase-changing water into steam since there is no need to maximize temperature to create the velocity.

Changes may be made in the above methods and systems without departing from the scope of the present embodiments. It should thus be noted that the matter contained in the above description or shown in the accompanying drawings should be interpreted as illustrative and not in a limiting sense. Herein, and unless otherwise indicated the phrase “in embodiments” is equivalent to the phrase “in certain embodiments,” and does not refer to all embodiments. The following claims are intended to cover all generic and specific features described herein, as well as all statements of the scope of the present method and system, which, as a matter of language, might be said to fall therebetween.

What is claimed is:

1. A monopropellant rocket thruster, comprising
a thruster housing including a reaction chamber and a divergent nozzle;
a pump, coupled to the thruster housing, operable to pump a monopropellant liquid into an inlet of the reaction chamber;
a decomposition catalyst, located near the inlet between the pump and the reaction chamber, configured to decompose at least one component of the monopropellant liquid into a mixture of liquid and gas in an exothermic reaction; and
an igniter, disposed at an outlet of the reaction chamber, such that the igniter ignites the mixture for producing expanding gas into the divergent nozzle.

2. The monopropellant rocket thruster of claim 1, wherein the monopropellant liquid comprises hydrogen peroxide, water, and a miscible fuel from a group including ethanol, methanol, and propanol.

3. The monopropellant rocket thruster of claim 1, wherein the monopropellant liquid passes through a material that includes the decomposition catalyst.

4. The monopropellant rocket thruster of claim 1, the decomposition catalyst comprising a metal screen that is electroplated with any one of platinum group metals, gold, magnesium dioxide, and a combination thereof.

5. The monopropellant rocket thruster of claim 1, wherein the igniter includes a pair of electrodes operable to produce an electric arc when powered.

6. The monopropellant rocket thruster of claim 5, wherein the pair of electrodes comprises two interdigitated electrodes.

7. The monopropellant rocket thruster of claim 5, wherein the pair of electrodes comprises a series of layers.

8. The monopropellant rocket thruster of claim 5, wherein a distance between the pair of electrodes is less than 1 millimeter.

9. A method for producing thrust in a rocket thruster, comprising:
pumping a monopropellant liquid into an inlet of a reaction chamber of the rocket thruster;
decomposing at least one component of the monopropellant liquid into a mixture of liquid and gas in an exothermic reaction using a decomposition catalyst near the inlet of the reaction chamber; and
igniting the mixture near an outlet of the reaction chamber for producing an expanding gas into a divergent nozzle of the rocket thruster.

10. The method of claim 9, in said step of decomposing, the monopropellant liquid passing through a material that includes the decomposition catalyst.

11. The method of claim 9, wherein the said step of igniting comprises creating an electric arc that ignites the mixture for producing the expanding gas.

12. The method of claim 9, wherein the monopropellant liquid comprises hydrogen peroxide, water, and a miscible fuel from a group including ethanol, methanol, and propanol.

13. The method of claim 12, in said step of decomposing, hydrogen peroxide decomposes into water and oxygen gas.

14. The method of claim 12, in said step of decomposing, the mixture including ethanol gas, oxygen gas, and water.
